(19) United States
(12) Patent Application Publication
(10) Pub. No.: US 2026/0261496 A1
(43) Pub. Date: Sep. 3, 2026

(54) MEASURING LATENCIES IN SERVICE MESH USING HTTP HEADER INJECTIONS

(71) Applicant: eBay Inc., San Jose, CA (US)

(72) Inventors: Boaz Ardel, Binyamina (IL); Ramprasad Ellupuru, Dublin, CA (US)

(21) Appl. No.: 19/067,016

(22) Filed: Feb. 28, 2025

(51) Int. Cl. H04L 43/045; H04L 41/0681; H04L 43/0852

(52) U.S. Cl. CPC H04L 43/045; H04L 41/0681; H04L 43/0852

(57) ABSTRACT

A method for measuring and analyzing latency in mesh networks, addressing the technical problem of identifying latency sources in complex network environments is described. The method involves injecting latency data into HTTP headers at multiple intermediary components within the network. This data is accumulated and used to calculate component-specific latencies by subtracting measurement values. The method enables the construction of histogram data to identify latency breakdowns, detect anomalies, and generate alerts.

### TECHNICAL FIELD

The present disclosure relates to computer networking technologies, specifically to measuring and analyzing network latencies using service mesh architectures.

### BACKGROUND

Accurately measuring and isolating network latencies is challenging in data centers and network environments. The complexity of network infrastructures, particularly those involving service meshes, often results in difficulties in pinpointing the exact source of latency issues. Traditional methods, such as sampled metrics, usually fall short of providing the granularity needed to detect minor changes or specific network issues. These limitations hinder efficiently detecting and mitigating infrastructure incidents, leading to prolonged downtime and potential financial losses.

Furthermore, existing solutions struggle to break down latency across various network components comprehensively. This lack of detailed visibility into the latency contributions of individual components within a service mesh complicates setting and maintaining service level indicators (SLIs) and service level objectives (SLOs).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a system diagram illustrating data flow and header injections through a service mesh architecture.

FIG. 2 is a schematic diagram illustrating the flow of latency measurements across various network components in a service mesh.

FIG. 3 is a block diagram illustrating the components of measuring mesh latency using service mesh sidecars.

FIG. 4 is a block diagram illustrating the data flow through a service mesh architecture, highlighting the measurement of gateway latency.

FIG. 5 is a block diagram illustrating the components involved in measuring server upstream latency within a service mesh architecture.

FIG. 6 is a flow chart diagram illustrating the process of injecting tracking data and latency measurements in HTTP headers within a mesh network.

FIG. 7 is a flow chart diagram illustrating accessing, extracting, and organizing latency measurements for alerts and anomaly detection.

FIG. 8 is a flow chart diagram illustrating calculating component-specific latency values within a mesh network.

FIG. 9 is a block diagram illustrating the architecture of a computing system for implementing latency measurement using HTTP header injections by service mesh.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art that embodiments of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

Accurately measuring and isolating latency across various components remains a challenge in network infrastructures. Network latencies are often difficult to pinpoint due to complex interaction between network elements, such as application proxies, load balancers, gateways, and service proxies. This complexity is further compounded in mesh networks, where multiple intermediary components are involved in the transmission of requests and responses. Traditional methods of measuring latency, such as sampled metrics from open-source projects implementing service mesh, often fall short of providing the granularity needed to detect minor changes or pinpoint specific network issues. These methods typically rely on an insufficient sampling process, which can obscure the performance of individual components and fail to provide insights for effective incident detection and resolution.

Current methods for measuring latency rely on client-side metrics, which may not accurately reflect network problems. These metrics can be affected by factors unrelated to network performance, such as delays in client processing or bottlenecks within the application. Furthermore, existing solutions often lack a comprehensive latency breakdown across all mesh network components. Establishing clear Service Level Indicators (SLIs) or Service Level Objectives (SLOs) for infrastructure latency is challenging. The resulting lack of detailed visibility can lead to longer times for detecting and resolving incidents as cloud teams and developers struggle to pinpoint the root causes of latency issues.

The present method addresses these challenges by introducing a novel approach for measuring latencies using HTTP header injections. This technique leverages the architecture of service meshes to inject latency data into HTTP headers at various points along the request path. The method enables the isolation and calculation of component-specific latencies by utilizing component proxies (e.g., Envoy sidecars) to measure latency and inject this data into the headers. This approach provides a high level of accuracy and granularity, allowing for the construction of detailed latency histograms and the early detection of network incidents. The method also facilitates the creation of SLIs and SLOs for each mesh component, enabling more efficient anomaly detection and incident triage. The approach offers an improvement over existing latency measurement techniques through the presently described use of service mesh architecture, providing cloud teams and developers with the tools needed to enhance observability and reduce incident response times. The present technique described herein is not restricted solely to service mesh environments; it offers the flexibility to be self-implemented across various network architectures. While the service mesh provides a convenient and efficient framework for injecting and managing latency data through sidecars and proxies, the underlying principles of this technique can be adapted to other network configurations. Organizations can implement the latency measurement process independently by integrating similar data injection and extraction mechanisms within their network infrastructure. This adaptability allows for the customization of latency tracking to suit specific network requirements and constraints, enabling precise performance analysis and optimization without being tied to a particular service mesh solution. By offering this versatility, the technique ensures that a wide range of network environments can benefit from enhanced latency measurement and management capabilities.

In one example embodiment, a method for measuring and analyzing latency in a mesh network by injecting latency data into HTTP headers at various intermediary components is described. This approach allows for precise tracking of latency across different network segments, enabling the identification of specific components contributing to delays. Using HTTP router filters to inject latency data into response headers, the method systematically gathers latency metrics without requiring significant changes to existing network infrastructure. This facilitates a detailed latency breakdown, allowing for targeted optimizations and troubleshooting. The ability to calculate component-specific latencies by subtracting measurement values from the headers enhances the granularity of network performance analysis, leading to improved network efficiency, reliability, and reduction in time to detect and mitigate root causes. This method is particularly advantageous in complex network environments where pinpointing latency sources is challenging, thus offering a practical solution for network performance management.

As a result, one or more of the methodologies described herein facilitate solving the technical problem of precise latency tracking across different network segments. As such, one or more of the methodologies described herein may obviate a need for certain efforts or computing resources that otherwise would be involved in requiring significant changes to existing network infrastructure. As a result, resources used by one or more machines, databases, or devices (e.g., within the environment) may be reduced. Examples of such computing resources include processor cycles, network traffic, memory usage, data storage capacity, power consumption, network bandwidth, and cooling capacity.

### Glossary

A mesh network is a network topology in which each node or device is interconnected with one or more other nodes, allowing data to be distributed efficiently across the network. This decentralized structure enhances network reliability and redundancy, as data can take multiple paths to reach its destination, reducing the risk of a single point of failure. Mesh networks are commonly used in wireless communication systems to provide robust and scalable connectivity.

A workload pod is a fundamental deployment unit in a container orchestration platform, such as Kubernetes, that encapsulates one or more containers. These containers share the same network namespace and storage resources, allowing them to communicate with each other efficiently. A workload pod is designed to host and execute application workloads, providing the environment for containers to run and interact. It includes specifications for resource allocation, such as CPU and memory, and can be configured with sidecars to extend its functionality for logging or monitoring purposes.

A sidecar is a secondary container or process that runs alongside a primary application container within the same pod in a containerized environment, such as Kubernetes. The sidecar is used to augment or enhance the functionality of the primary application by providing additional services, such as logging, monitoring, or network proxying. In the context of a service mesh, a sidecar often acts as a proxy that intercepts and manages network traffic between microservices, enabling features like traffic management, security, and observability without modifying the application code.

An Envoy sidecar is a lightweight proxy deployed as a sidecar container within a pod in a service mesh architecture. It is based on the Envoy proxy, an open-source edge and service proxy designed for cloud-native applications. The Envoy sidecar intercepts and manages all inbound and outbound network traffic to and from the application container within the same pod. This setup enables advanced traffic management features such as load balancing, service discovery, health checking, and observability. In a service mesh, the Envoy sidecar facilitates secure and reliable communication between microservices, allowing for consistent policy enforcement and telemetry collection without modifying the application code.

Istio is an open-source service mesh platform that provides a uniform way to connect, secure, control, and observe microservices. It deploys a network of Envoy sidecar proxies alongside application services, which manage the communication between microservices. Istio offers features such as traffic management, security, policy enforcement, and telemetry collection, enabling developers to manage complex microservice architectures with greater ease and flexibility. By abstracting the network layer, Istio allows for consistent and centralized control over service interactions without requiring changes to the application code.

The term “service” refers to a software function or a set of functions made available over a network, such as the Internet, to support other software applications or systems. Services are typically designed to perform specific tasks, such as processing data, managing resources, or facilitating communication between different software components, and they often operate within a service-oriented architecture (SOA) or microservices architecture. Clients or other services can access and utilize them through standardized protocols and interfaces, such as HTTP or REST APIs (Representational State Transfer Application Programming Interface).

The term “injection” refers to inserting additional data or code into an existing data stream or system. This process is often used to enhance or modify the behavior of the system by adding metadata, such as latency measurements, into network packets or headers. In service mesh architectures, injection involves adding specific data, like latency metrics, into HTTP headers as requests and responses traverse various components, enabling detailed tracking and analysis of network performance.

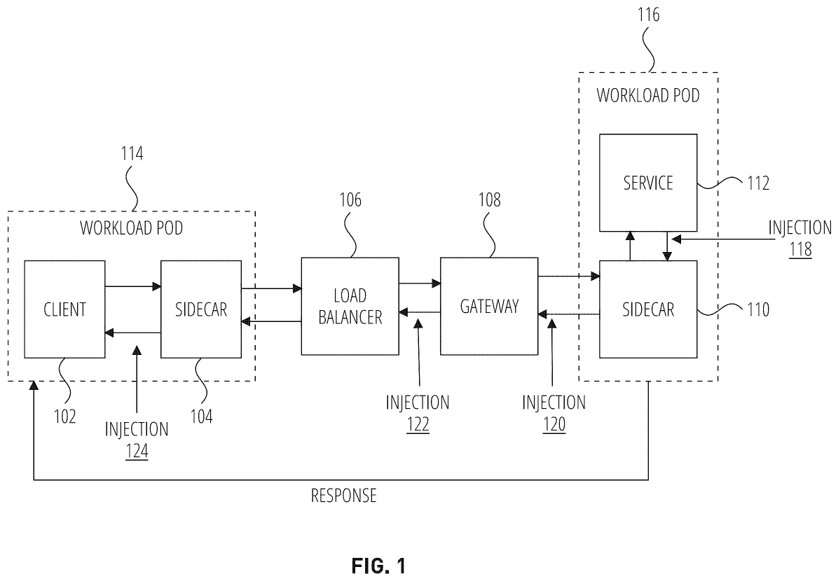

FIG. 1 shows a system architecture for latency measurement in a mesh network comprising a client 102, a sidecar 104, a load balancer 106, a gateway 108, a sidecar 110, a service 112, a workload pod 114, a workload pod 116, and injections 118, 120, 122, and 124. The system facilitates the transmission of requests and responses through various components, injecting latency data at multiple points to enable precise latency calculations.

Client 102 initiates a request that traverses the network to reach service 112. In one example, client 102 is a software application or a user interface that seeks data or services from the server-side components. In this architecture, client 102 is part of a workload pod 114 that encapsulates the client application and the associated sidecar 104. The workload pod 114 provides an isolated environment for the client application of client 102 to operate.

Sidecar 104 operates alongside the client 102 within the workload pod 114. Sidecar 104 is an intermediary that intercepts network traffic between client 102 and the subsequent network components.

Load balancer 106 is a network component that distributes incoming client requests across multiple servers or services to optimize resource utilization, reduce latency, and ensure high availability. In FIG. 1, load balancer 106 receives requests from sidecar 104 and forwards them to gateway 108. Load balancer 106 manages traffic flow and ensures that no single server is overwhelmed with requests, thereby maintaining the overall performance and reliability of the network.

Gateway 108 is an internal network entry point, providing a controlled access point for external requests. Gateway 108 bridges external client requests (e.g., client 102) and internal services (e.g., service 112). Gateway 108 routes requests to the appropriate service based on predefined rules and policies. In the architecture of FIG. 1, gateway 108 receives requests from load balancer 106 and forwards them to sidecar 110 associated with service 112.

Sidecar 110 functions similarly to sidecar 104 but is associated with service 112 within the workload pod 116. Sidecar 110 intercepts network traffic between gateway 108 and service 112.

Service 112 is the endpoint that processes client requests and generates the corresponding responses. Service 112 operates within the workload pod 116 alongside the sidecar 110. Service 112 is responsible for executing the business logic or operations to fulfill requests from client 102, and its performance influences the overall network latency analysis.

Workload pod 116 encapsulates service 112 and sidecar 110. Workload pod 116 serves as the basic deployment unit in a containerized environment, such as Kubernetes, and provides the resources and isolation for the applications to run efficiently.

In the architecture depicted in FIG. 1, the response flow begins at server 112, which processes the client's request and generates the response. Once the response is ready, it is sent back through the network, retracing the path taken by the initial request. As the response travels from service 112 to client 102, the response passes through several intermediary components, each playing a role in managing the flow and injecting latency data into the HTTP headers.

For example, sidecar 110 injects latency data (e.g., injection 118 and injection 120) specific to the server's processing time into the HTTP headers. This data provides insights into the time taken by the server 112 to handle the request, contributing to the overall latency analysis.

Next, the response moves to the gateway 108. At this stage, gateway 108 injects additional latency data (e.g., injection 122) into the HTTP headers, capturing the time the response takes to pass through gateway 108. This information can be used to identify the gateway's impact on the overall latency.

The response then reaches the load balancer 106, which continues to manage network traffic distribution. Finally, the response arrives at the sidecar 104 associated with the client 102. The sidecar 104 injects the final set of latency data (e.g., injection 124) into the HTTP headers, capturing the time the response takes to reach client 102. This comprehensive set of latency measurements, accumulated at each component, allows the client 102 to perform a detailed analysis of the network's performance, identifying potential bottlenecks and areas for optimization. The systematic injection of latency data at each stage of the response flow provides a complete picture of the network's latency profile, enabling precise performance monitoring and management.

FIG. 1 illustrates injection points 118, 120, 122, and 124, which represent locations in the network where latency measurement data is added to the HTTP headers. These injections occur at various stages of the network path, including between the client 102 and the sidecar 104, the load balancer 106 and the gateway 108, and the gateway 108 and the sidecar 110. The injections are not limited to the above and can occur at other locations in the network path. By injecting latency data at multiple points, the system can provide a detailed breakdown of the latency experienced at each stage.

In the context of the described network architecture of FIG. 1, latency data is systematically injected into the HTTP headers of responses as they traverse through various components. Each component in the network, such as sidecar 104, sidecar 110, gateway 108, and load balancer 106, contributes to this process by adding its latency measurement to the HTTP headers. Each latency data is associated with a unique key name to ensure that these measurements are easily identifiable and can be accurately attributed to their respective components. These unique key names serve as identifiers that distinguish the latency data of one component from another, allowing for precise analysis and tracking of network performance.

A unique key name is a distinct identifier assigned to the latency data injected by a specific component in the network. This key name is included in the HTTP headers alongside the corresponding measure value, representing the time the component takes to process the request or response takes. By using unique key names, the system can maintain a clear and organized record of latency measurements, facilitating the isolation and analysis of latency contributions from individual components. This approach is particularly useful in complex network environments, where multiple components may be involved in processing a single request or response.

For example, FIG. 1 illustrates a network where a request passes through a client-side sidecar 104, the load balancer 106, the gateway 108, and the sidecar 110. Each of these components injects its latency data into the HTTP headers, using unique key names such as “client-sidecar-latency,” “load-balancer-latency,” “gateway-latency,” and “server-sidecar-latency.” Each key name is paired with a measure value, such as “client-sidecar-latency: 15 ms,” indicating the time the client-side sidecar 104 takes to process the request. This structured approach allows for easy identification and comparison of latency data across different components, enabling cloud teams and developers to pinpoint specific latency areas and optimize performance accordingly.

Using unique key names in latency data injection not only enhances the clarity and organization of the collected data but also supports advanced analysis techniques. Cloud teams and developers can perform targeted optimizations, identify potential bottlenecks, and implement strategies to improve overall network efficiency by having a detailed breakdown of latency contributions from each component. This method provides a comprehensive view of the network's latency profile, empowering administrators to make informed decisions and maintain high levels of performance and reliability.

In another example embodiment, the system described in FIG. 1 allows for flexibility and architectural decisions in the service mesh's measurement process. For example, the measurement process is initiated by sidecar 104, which injects latency data into HTTP headers as requests are processed. This process is not limited to service mesh environments. The measurement begins when the request is handled by sidecar 104 and continues as the request traverses through various network components. The process is completed when the response returns to sidecar 104, allowing for a comprehensive accumulation of latency data. This approach ensures that the latency measurements are accurately captured and reflect the entire journey of the request and response through the network, providing insights into network performance.

The presently described system architecture for measuring latency in a mesh network is lightweight and efficient, seamlessly integrating into client applications as a platform dependency. This design ensures that each client application includes a component that functions as a filter plugin responsible for managing all data construction related to latency measurement. By embedding this functionality as a platform dependency, the system operates unobtrusively within the client applications, allowing them to receive the filter plugin without being aware of its presence. This approach enhances coverage across various client environments, accurately reflecting real traffic latencies and improving the system's detection capabilities.

The system architecture for measuring latency in a mesh network ensures that latency measurement and detection are effectively integrated across various workload services. Many of these services include the necessary dependencies and are designed to operate across multiple platforms. This cross-platform capability helps maintain consistent performance and reliability, regardless of the underlying technology stack.

The system architecture is also designed to accommodate various client dependencies in client applications, including REST clients, SQL clients, and GraphQL clients. This flexibility allows the filter plugin to be integrated as needed, supporting different clients' diverse technologies and protocols. The system can effectively capture and analyze latency data by ensuring extensive coverage across these various client dependencies.

Implementing this system facilitates widespread adoption and consistent application across various client environments. Its thin and efficient design minimizes the impact on client applications while maximizing the ability to monitor and analyze real traffic latencies. This approach enhances the system's detection capabilities and ensures that it remains adaptable and scalable, meeting the evolving needs of modern network infrastructures.

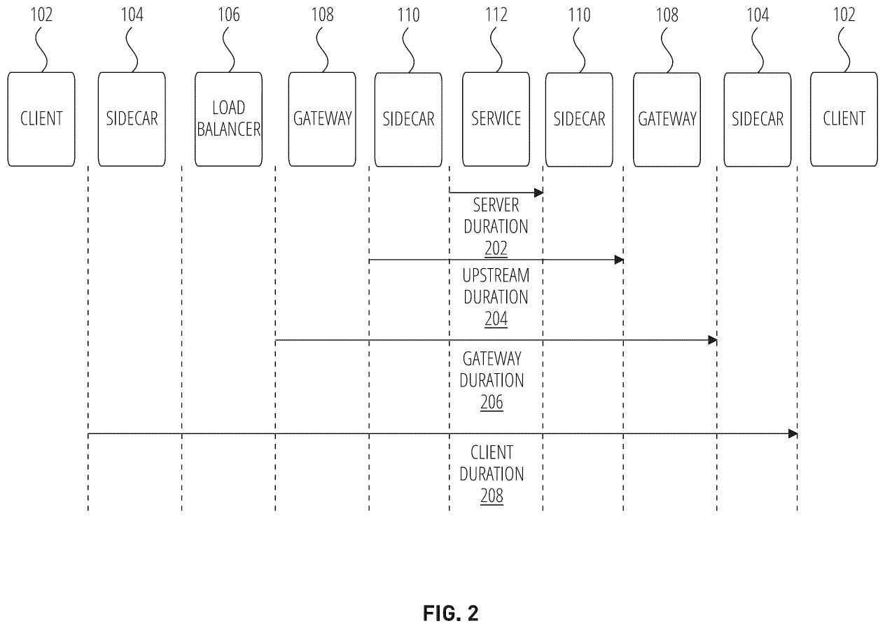

FIG. 2 is a schematic diagram illustrating the flow of latency measurements across various network components and their respective duration in a service mesh. FIG. 2 illustrates communication between client 102, sidecar 104, load balancer 106, gateway 108, sidecar 110, and service 112. Additionally, FIG. 2 illustrates server duration 202, upstream duration 204, gateway duration 206, and client duration 208, which are metrics for assessing the latency across the network.

Client 102 initiates a request that traverses through the network, interacting with several intermediary components. Sidecar 104 is associated with client 102 and manages network communications and injects latency measurements into the HTTP headers. Sidecar 104 enables capturing the client duration 208, which measures the time taken for the request to travel from client 102 to service 112 and back.

Load balancer 106 is positioned between sidecar 104 and gateway 108. Load balancer 106 distributes incoming network traffic across multiple servers. Gateway 108, which follows the load balancer 106, serves as an entry point to the network, managing and routing requests to the appropriate destinations. The gateway duration 206 is recorded here, reflecting the time taken for the request to pass through gateway 108.

Sidecar 110 is linked to service 112, similar to client 102, and is tasked with monitoring and managing the network traffic specific to service 112. Sidecar 110 allows for measuring the server duration 202, which indicates the time taken by service 112 to process the request. Additionally, the upstream duration 204 is recorded, representing the time taken for the request to travel from gateway 108 to service 112.

Service 112 is the endpoint that processes the client's request and generates a response. Service 112 operates with sidecar 110 to ensure that latency data is accurately captured and injected into the HTTP headers.

As described above, the measurement begins when the request is first handled by sidecar 104 and continues as the request traverses through various network components. The process is completed when the response returns to sidecar 104, allowing for a comprehensive accumulation of latency data. The accumulated latency data is used to compute the server duration 202, upstream duration 204, gateway duration 206, and client duration 208.

The client 102 calculates component-specific latencies by utilizing the latency data embedded within the HTTP headers of network responses. This approach involves subtracting a first duration value (e.g., server duration 202) from a second duration value (e.g., upstream duration 204), both recorded in the headers as the response traverses through various network components. The subtraction of these values allows for determining the network latency specific to a particular component, providing a granular view of the time each component takes to process the request or response.

The method involves identifying two relevant duration values from the headers to calculate a component-specific latency. The first duration value represents the time taken by the component of interest, while the second duration value corresponds to the time taken by a preceding or subsequent component. By subtracting the first duration value from the second, the method isolates the latency introduced by the specific component, effectively removing the influence of other components in the network path.

This subtraction-based approach provides several advantages. It allows for precise measurement of the latency contributions of individual components, enabling cloud teams and developers to identify and address specific bottlenecks or inefficiencies. Additionally, by focusing on component-specific latencies, the method supports targeted optimizations that enhance overall network performance. This level of detail is particularly valuable in complex network environments, where multiple components interact and contribute to the total latency experienced by a request.

Furthermore, the ability to calculate component-specific latencies through subtraction supports advanced network analysis and monitoring. By maintaining a detailed record of latency data for each component, cloud teams and developers can track performance trends, detect anomalies, and implement proactive measures to prevent potential issues.

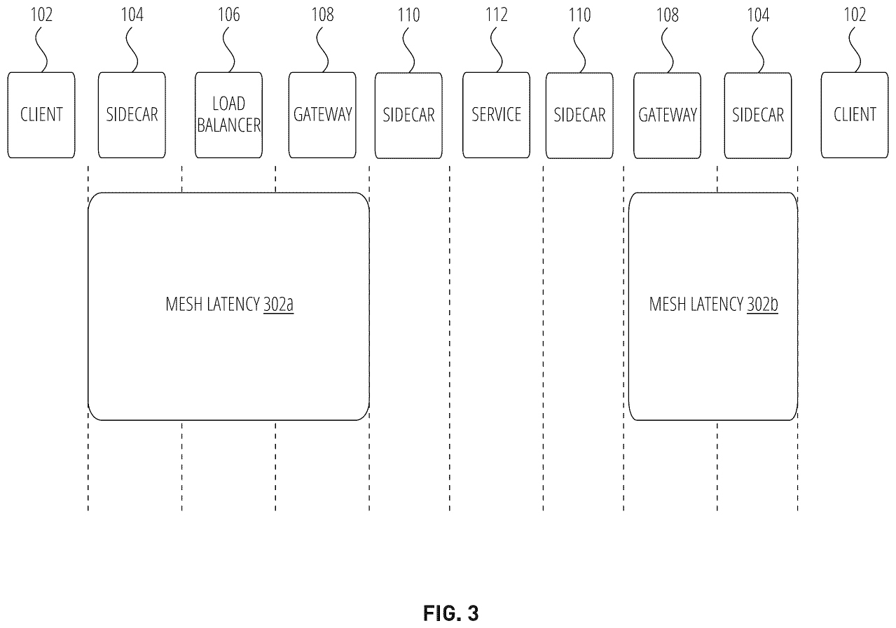

FIG. 3 shows a system architecture for measuring and analyzing latency within a mesh network. FIG. 3 illustrates client 102, sidecar 104, load balancer 106, gateway 108, sidecar 110, service 112, and mesh latency 302a. These components interact to facilitate the transmission of requests and responses, while also enabling latency measurement at various points in the network.

Mesh latency 302a represents the latency experienced by a request as the request traverses the network. Mesh latency 302b represents the latency experienced by a response as the response traverses the network. The calculation is performed by aggregating the latency data injected by sidecars 104, 110, and other components in the network, including gateway 108. In one example, mesh latency 302a and mesh latency 302b are calculated by subtracting measurement data injected by sidecar 110 and measurement data injected by sidecar 104. In one example, the latency measurement is injected with a unique key name to the HTTP header in the response. The injections along the way are accumulated in the HTTP header.

In another example embodiment, mesh latency 302a and mesh latency 302b are calculated by aggregating and analyzing the latency data collected at various points along the request path within the service mesh. This involves the following steps:
1. Latency Data Injection: As a request traverses through the network, latency data is injected into the HTTP headers at each intermediary component, such as sidecar 104, sidecar 110, load balancer 106, and gateway 108. Each component records the time taken for the request to pass through it.
2. Data Collection: The injected latency data is collected as the request moves from client 102 to service 112 and back. This data includes specific duration values for each component, such as client, gateway, upstream, and server duration.
3. Latency Calculation: Once the response returns to client 102, the collected latency data is extracted from the HTTP headers. The mesh latency is then calculated by subtracting the upstream duration 204 from the client duration 208. This calculation isolates the time the mesh network takes, excluding the time spent on the server. The latency calculation method described herein allows for the subtraction of measurements to isolate various network flows, even those that are not necessarily continuous. This capability is achieved by capturing latency data at multiple points along the request path and storing these measurements in HTTP headers. By analyzing the differences between these measurements, it is possible to isolate specific segments of the network flow and determine the latency associated with each segment. This approach identifies discrete latency contributions from different components, such as proxies, gateways, or application servers, regardless of whether the data flow is continuous or segmented.

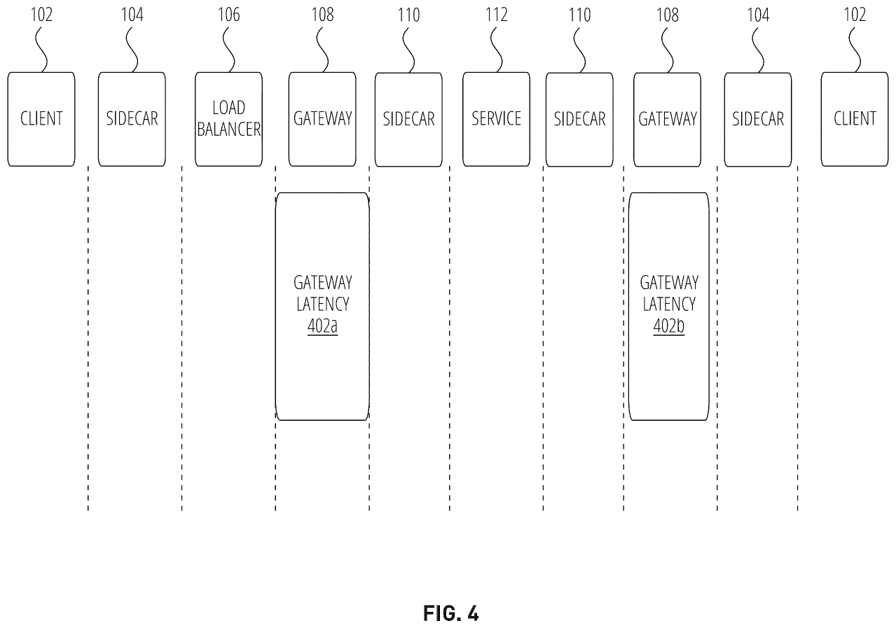

FIG. 4 is a block diagram illustrating the data flow through a service mesh architecture, highlighting the measurement of gateway latency 402a and gateway latency 402b. The gateway latency 402a is calculated by measuring the time duration from when a request first reaches gateway 108 until the response leaves gateway 108. The gateway latency 402b is calculated by measuring the time duration from when a response first reaches gateway 108 until the response leaves gateway 108. These measurements encompass the entire processing time within gateway 108, including any operations performed by sidecar 110, which handles network traffic and applies filters. The latency is captured by injecting specific headers into the HTTP request and response flow, allowing for precise tracking of the time spent at the gateway.

By subtracting the upstream duration 204 from the gateway duration 206, the gateway latency 402a and gateway latency 402b can be isolated, clearly indicating the time the gateway consumes in processing the request.

In another example embodiment, gateway latency 402a is calculated by measuring the time taken for a request to be processed as it passes through the gateway 108 of a network. This involves the following steps:
1. Request Arrival: The measurement begins when the request arrives at gateway 108. This initial time measurement marks the start of gateway 108 processing time.
2. Processing Time: gateway 108 performs various operations on the request, such as routing, security checks, and protocol translations. The time taken for these operations contributes to the overall gateway latency.
3. Response Departure: The measurement concludes when the response leaves gateway 108. This final time measurement marks the end of gateway 108 processing time.
4. Latency Calculation: gateway latency 402 a is calculated by subtracting the initial time measurement (request arrival) from the final time measurement (response departure). This calculation provides the total time spent by the request within gateway 108.

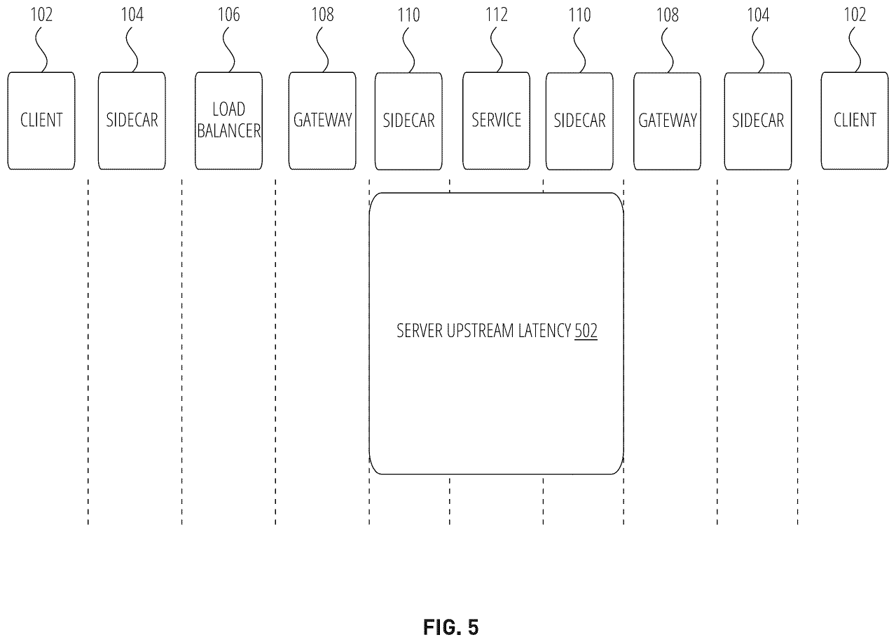

FIG. 5 is a block diagram illustrating the components in measuring server upstream latency 502 within a service mesh architecture. The server upstream latency 502 represents the cumulative latency experienced by requests as they traverse from gateway 108 to the service 112 and back. The server upstream latency 502 is calculated by subtracting the server duration 202 from the upstream duration 204.

In another example embodiment, server upstream latency 502 is calculated by measuring the time a request takes to travel from gateway 108 to service 112 and back to gateway 108. This involves the following steps:
1. Request Arrival at Gateway: The measurement begins when the request arrives at gateway 108. This initial time measurement marks the start of the upstream journey.
2. Traversal to Service: The request is forwarded from gateway 108 to service 112, passing through intermediary components such as sidecar 110. The time taken for this traversal is part of the upstream latency.
3. Service Processing: service 112 processes the request and generates a response. The time taken for this processing is included in the upstream latency.
4. Response Return to Gateway: The response travels back to gateway 108. The final time measurement is recorded when the response arrives at gateway 108, marking the end of the upstream journey.
5. Latency Calculation: The server upstream latency 502 is calculated by subtracting the initial time measurement (request arrival at the gateway) from the final time measurement (response return to the gateway). This calculation provides the total time the request and response spends in the upstream path.

The latency measurement technique described herein is not confined to traditional metrics such as server duration, upstream duration, gateway duration, or client duration. Instead, the technique is designed to be versatile and applicable to any component within a mesh network. This flexibility is achieved by leveraging the service mesh architecture, which allows for injecting latency measurements at various points along the request path. Each network component, whether an application proxy, load balancer, or any other intermediary, can be configured to inject distinct latency data into the HTTP headers. This approach enables a comprehensive analysis of the network's performance by providing detailed insights into the latency introduced by each component. As a result, cloud teams and developers can pinpoint specific areas of latency, facilitating more efficient troubleshooting and optimization of the network infrastructure. This method ensures that latency measurements are accurate and reflective of the entire network's performance, thereby enhancing the overall observability and reliability of the system.

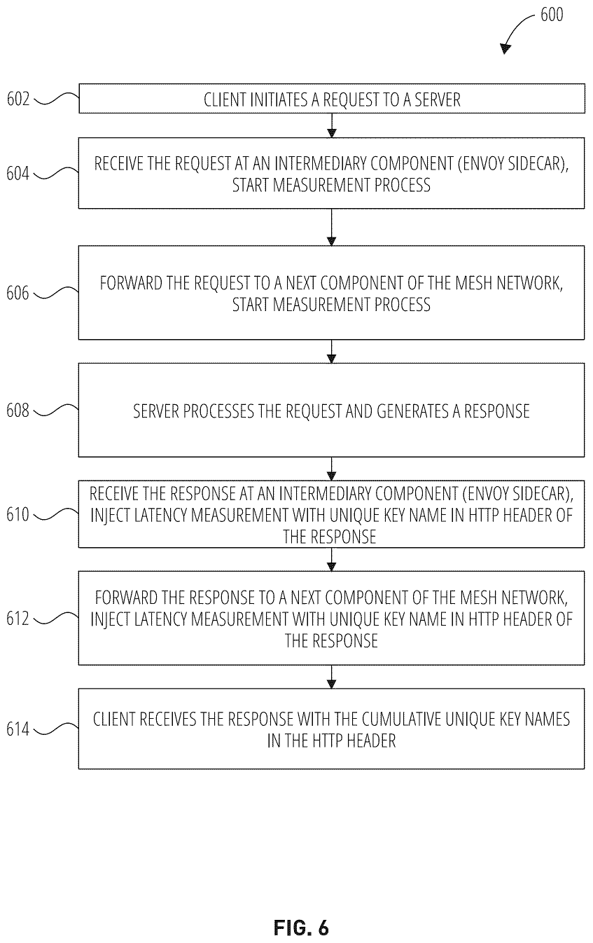

FIG. 6 is a flow chart diagram illustrating the process of injecting tracking data and latency measurements in HTTP headers within a mesh network. Although the example routine 600 depicts a particular sequence of operations, the sequence may be altered without departing from the scope of the present disclosure. For example, some of the operations depicted may be performed in parallel or in a different sequence that does not materially affect the function of the routine 600. In other examples, different components of an example device or system that implements the routine 600 may perform functions simultaneously or in a specific sequence. The routine 600 can be implemented by various components within the network and facilitates the tracking of latency across different components in the network by injecting latency measurements into HTTP headers.

At step 602, client 102 initiates a request to service 112. This step marks the beginning of the process where client 102 sends a request that traverses through various mesh network components.

At step 604, the request is received at an intermediary component, for example, sidecar 104, where the measurement process begins. This step involves the initial recording of latency data as the request enters the intermediary component.

At step 606, the request is forwarded to the subsequent component of the mesh network, and the measurement process continues. Each intermediary component in the path records the component's latency data, contributing to the overall measurement process.

At step 608, service 112 processes the request and generates a response. This step involves service 112 executing the operations to fulfill the request and prepare a response to be sent back to client 102.

At step 610, the response is received at an intermediary component (604) (e.g., sidecar 110), where latency measurement is injected with a distinct identifier name into the HTTP header of the response. This step ensures that the latency data is recorded and associated with a particular identifier for identification. In one example embodiment, block 610 specifies that the overhead of the injected latency data remains below a preset overhead threshold. This threshold is determined based on the network's capacity, performance requirements, and the acceptable trade-off between data granularity and system efficiency. By adhering to this constraint, routine 600 ensures that the network can operate smoothly without delays or resource consumption caused by the additional data.

At step 612, the response is forwarded to the next component of the mesh network, with the latency measurement being injected with a distinct identifier name into the HTTP header of the response. This step continues accumulating latency data as the response traverses back through the network.

At step 614, client 102 receives the response with the cumulative distinct identifiers in the HTTP header. This final step allows block 602 to access the complete set of latency data, enabling the calculation of component-specific latencies based on the accumulated measurements.

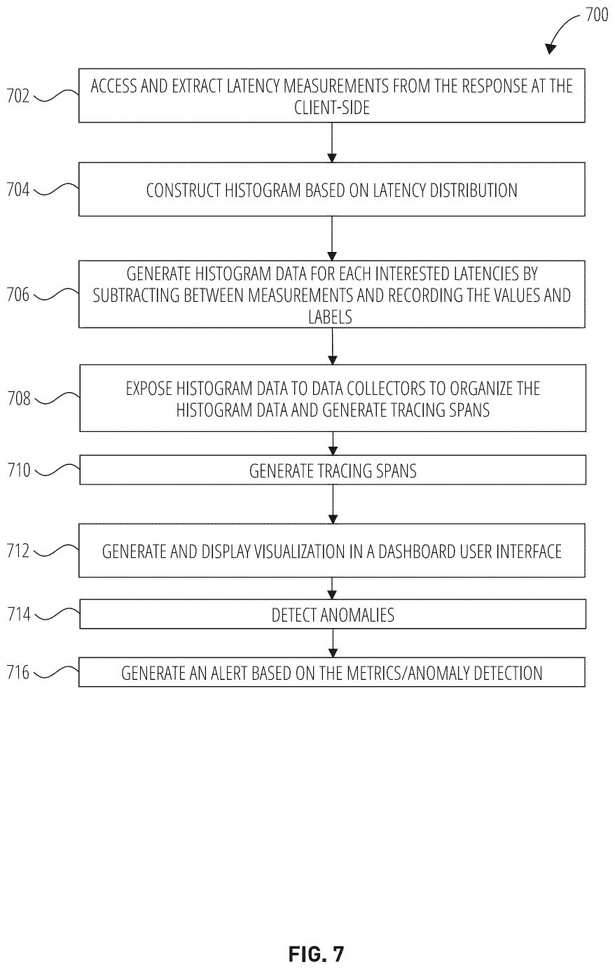

FIG. 7 is a flowchart illustrating accessing, extracting, and organizing latency measurements. The collected data can be used for metrics, tracing, alerts, recording rules, and anomaly detection. Although the example routine 700 depicts a specific sequence of operations, this sequence can be modified without deviating from the scope of the present disclosure. For instance, some operations may be performed in parallel or in a different order that does not materially affect the function of routine 700. In other scenarios, different components of a device or system implementing routine 700 may execute functions simultaneously or in a particular sequence. A client-side platform can implement routine 700 to analyze and organize latency data collected from network interactions. In another example embodiment, a different component can execute the data extraction and histogram creation.

In one example embodiment, FIG. 7 represents an implementation as a platform dependency within client applications. Each client application includes a dependency integrated into its platform, where the code operates as a filter plugin. This plugin is responsible for all data construction, including accessing, extracting, and organizing latency measurements. Client applications receive this filter as part of the platform and remain unaware of the underlying implementation. This approach is designed to achieve high coverage, accurately reflecting real traffic latencies and leading to improved detection of network performance issues.

The implementation is lightweight and efficient, ensuring minimal impact on the performance of the client application while providing comprehensive insights into network latency. By embedding this functionality as a platform dependency, the method promotes widespread adoption and consistent application across various client environments, thereby enhancing the overall effectiveness of latency monitoring and analysis.

At block 702, the client side (e.g., client 102) accesses and extracts latency measurements from the response. For instance, client 102 retrieves the data included in the HTTP headers, which provide latency information accumulated during the request's journey through the network.

At block 704, client 102 constructs a histogram to illustrate the latency distribution. In this example, the histogram displays data based on the latencies of specific components, organized according to the expected latency ranges for each intermediary component. This approach offers a structured representation of latency data, enabling cloud teams and developers to effectively analyze and interpret the performance of various network components.

The process starts with collecting component-specific latencies, calculated by subtracting the duration values recorded in the HTTP headers as responses move through the network. These latencies are subsequently arranged into histograms representing the distribution of latency values across different components.

In one example, a histogram is a type of data representation that illustrates the distribution of values. In the current implementation, this data is made available in a textual format at specific endpoints within the client applications. Access to this data and its analysis are facilitated by a dependency integrated into the client platform.

Expected latency ranges are predefined intervals that signify the anticipated time required for a network component to process a request or response under normal operating conditions. These ranges are established based on historical performance data, the network architecture, and the specific functions of each component. For instance, a sidecar proxy may have an expected latency range of 5 to 10 milliseconds, while a gateway might have a range of 15 to 25 milliseconds. These ranges are benchmarks for evaluating whether a component performs within its expected parameters.

By distributing component-specific latencies within the histogram according to these expected latency ranges, cloud teams and developers can easily determine if a component's performance is within the normal range or deviates from expected behavior. If the latency values fall outside the expected range, this may indicate a performance issue or bottleneck. Conversely, the component functions as intended if the values are within the expected range.

Histograms capture the distribution of values across various network components. While the histograms represent raw data, they are the foundation for advanced visualizations and anomaly detection tools. These tools utilize histogram data to create visual representations that simplify the interpretation and analysis of network performance. Additionally, anomaly detection mechanisms leverage histogram data to identify deviations from expected patterns, triggering alerts when potential issues are detected.

At block 706, client 102 generates histogram data for each interested latency by subtracting between measurements and recording the values and labels. This step involves calculating the specific latencies of different network components by analyzing the extracted data and then organizing this information into histograms. These histograms are tailored to reflect the distribution of each of the desired latencies, providing a visual representation that aids in identifying patterns and anomalies.

At block 708, the histogram data is exposed to data collectors to organize the histogram data. This step ensures that the processed data is available to centralized data collectors (or other services and implementations), which can further analyze and maintain the metrics. This organized data serves as a basis for generating insights, enabling anomaly detection, and supporting the creation of visibility dashboards for network performance monitoring, including but not limited to metrics, traces, recording rules, alerts, and anomaly detection.

At block 710, after exposing histogram data to data collectors, the next step involves generating tracing spans using OpenTelemetry. Once the histogram data is exposed, it serves as a foundational dataset that reflects the distribution of latencies across various network components. OpenTelemetry is a tool that enables the collection of telemetry data, including traces, metrics, and logs, from distributed systems. By generating tracing spans, OpenTelemetry provides a detailed record of the sequence of operations as a request traverses the network. Each span represents a single operation within the request path, capturing important information such as the start and end times, duration, and associated metadata. The tracing spans provide a chronological view of the request flow. The combination of histogram data and tracing spans offers a comprehensive approach to network performance monitoring. While histograms provide a high-level overview of latency distributions, tracing spans deliver granular insights into the specific operations and interactions contributing to those latencies.

At block 712, client 102 generates and displays a visualization based on the histogram from block 704 and the detected anomalies within a dashboard user interface. Dashboards are designed to present complex data clearly and concisely, using charts, graphs, and other visual elements to effectively convey information. This user-friendly interface allows cloud teams and developers to quickly assess the network's health, identify trends, and detect anomalies.

The dashboard facilitates informed decision-making and efficient troubleshooting by presenting latency breakdowns in a visual format. Cloud teams and developers can easily pinpoint areas of concern, such as components operating outside their expected latency ranges or experiencing performance bottlenecks. This visibility enables targeted optimizations and proactive maintenance, ensuring the network operates efficiently and reliably. Furthermore, the dashboard user interface supports real-time monitoring and analysis, allowing cloud teams and developers to respond swiftly to changes in network conditions.

At block 714, client 102 identifies anomalies in network performance by analyzing deviations in histogram data from expected latency ranges. This method takes advantage of the high resolution and sensitivity of the histogram fitted in block 704 to detect unusual patterns or outliers that may indicate potential issues within the network. These histograms display the distribution of latency values across different network components. Each component has predefined expected latency ranges, which serve as benchmarks for normal performance. These ranges are established based on historical data, network architecture, and the specific roles of each component.

In another example embodiment, the anomaly detection tool analyzes various factors and cross-correlations and can be applied to multiple data sources. By integrating latency measurements with histogram data, the anomaly detection tool provides a more comprehensive view of network behavior, leading to more accurate and insightful anomaly detection. Additionally, the actual latency values recorded in the histograms are compared against the expected ranges. When latency values deviate from these expected ranges, it suggests that a component may be experiencing performance issues or inefficiencies. Such deviations can present as outliers or shifts in the distribution of latency values within the histogram.

At block 716, client 102 generates an alert based on the metrics and anomalies detected in block 714. In one example embodiment, block 716 generates SLI or SLO visualizations based on the detailed latency data collected from various components within the mesh network. SLIs are metrics that quantify the performance of a service, such as response time or availability, while SLOs are specific targets set for these metrics. By visualizing SLIs or SLOs, cloud teams, and developers can easily assess whether the network meets its performance targets and identify areas flagged for attention.

These visualizations enable alert generation when performance deviates from the established SLI or SLO thresholds. For instance, if a component's latency exceeds the acceptable range defined by an SLO, an alert can be triggered to notify cloud teams and developers of the potential issue. This proactive alerting mechanism enables timely intervention and remediation, preventing minor performance degradations from escalating into disruptions.

In addition to visualization and alerting, block 716 enables tracing by providing detailed latency measurements for each component in a request path. This involves capturing HTTP status codes and mesh-specific measurements for each span, offering a comprehensive view of the request's journey through the network. Tracing allows cloud teams and developers to track requests and responses, identify bottlenecks, and understand the interactions between different components.

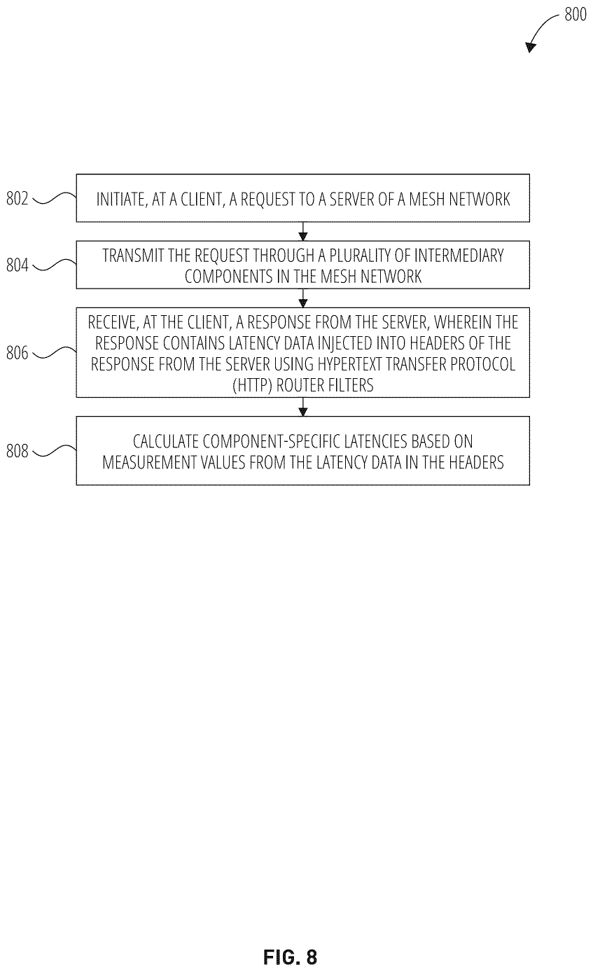

FIG. 8 is a flow chart diagram illustrating the process (e.g., routine 800) of calculating component-specific latency values within a mesh network. Although routine 800 depicts a particular sequence of operations, the sequence may be altered without departing from the scope of the present disclosure. For example, some of the operations depicted may be performed in parallel or in a different sequence that does not materially affect the function of the routine 800. In other examples, different components of an example device or system that implements the routine 800 may perform functions simultaneously or in a specific sequence. Routine 800 can be implemented by client 102 to analyze and organize latency data collected from network interactions. In other example embodiments, extraction and histogram creation can be performed on another component.

At block 802, client 102 initiates a request to be sent to service 112 within the mesh network. This first step involves client 102 preparing the request for transmission, ensuring that it is properly formatted and ready to traverse the network. Client 102 is the starting point for data flow, initiating a sequence of interactions across the network's components.

Once the request is prepared, it is transmitted through a series of intermediary components within the mesh network at block 804. These components may include sidecars, load balancers, gateways, and other network elements that assist in routing and processing the request. As the request moves through these components, each may perform specific functions such as load balancing, security checks, or protocol translations. Additionally, these components inject latency data into the HTTP headers, using HTTP router filters to capture the time taken for the request to pass through each stage.

After service 112 processes the request, it generates a response. As this response returns to client 102, it accumulates latency data at each component it traverses. This accumulation of latency data occurs as the response passes through various network elements. Each component appends its latency measurement to the response headers, resulting in a comprehensive record of the time taken at each stage of the network path. By the time the response reaches the client, it contains a detailed aggregation of this latency data.

At block 806, client 102 receives the response, now enhanced with detailed latency measurements that reflect the performance of each component along the request path. Finally, at block 808, client 102 calculates component-specific latencies based on the values extracted from the latency data in the headers. By analyzing these values, client 102 determines the time each component takes to process the request, isolating the contributions of individual elements to the overall network latency.

In an alternative embodiment, routine 800 describes a method for optimizing network performance by identifying application proxies that operate efficiently within a service mesh environment. This method utilizes latency measurements to ensure that only proxies meeting specific performance criteria are selected, thus enhancing the overall efficiency and reliability of the network.

Specifically, an application proxy is identified when its latency value falls below a predetermined threshold. This threshold is set based on the network's performance requirements and is a benchmark for acceptable latency levels. By monitoring the latency data gathered from various network components, developers can identify which application proxies are within the desired latency range.

Once an application proxy is identified as having a latency value below the preset threshold, routine 800 progresses to operate the service mesh with this proxy. This enables the network to leverage efficient proxies, reducing latency and optimizing resource utilization.

In addition to monitoring for latency spikes that exceed predefined thresholds, the system verifies that the latencies of individual components align with established Service Level Objectives (SLOs) and Service Level Indicators (SLIs). This involves a thorough evaluation to confirm that each component's latency remains within acceptable limits and does not exhibit any anomalies.

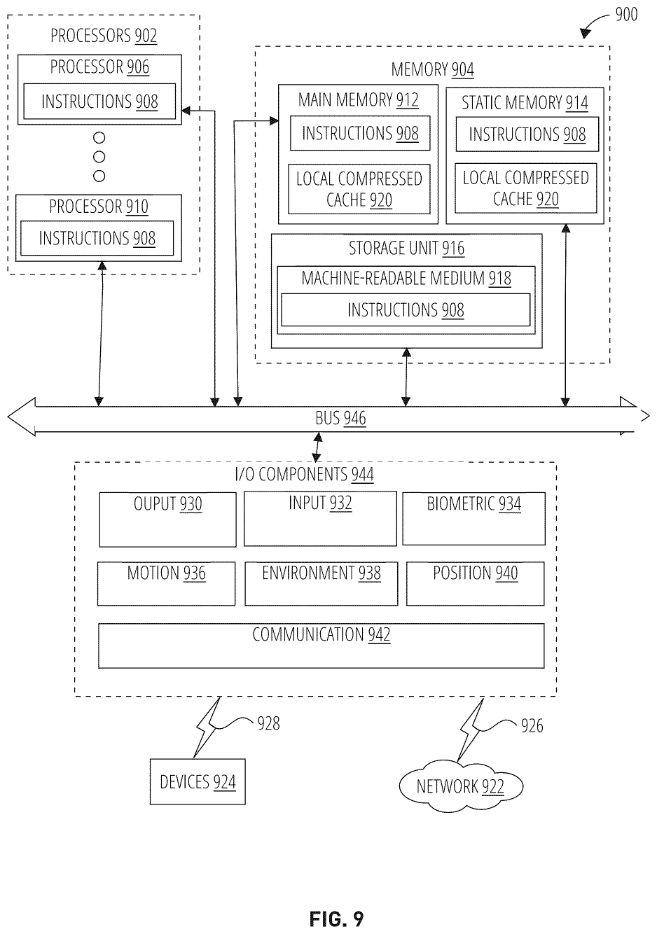

FIG. 9 is a diagrammatic representation of the machine 900 within which instructions 908 (e.g., software, a program, an application, an applet, an app, or other executable code) for causing the machine 900 to perform any one or more of the methodologies discussed herein may be executed. For example, the instructions 908 may cause the machine 900 to execute any one or more of the methods described herein. The instructions 908 transform the general, non-programmed machine 900 into a particular machine 900 programmed to carry out the described and illustrated functions in the manner described. The machine 900 may operate as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 908, sequentially or otherwise, that specify actions to be taken by the machine 900. Further, while only a single machine 900 is illustrated, the term “machine” shall also be taken to include a collection of machines that individually or jointly execute the instructions 908 to perform any one or more of the methodologies discussed herein.

The machine 900 may include Processors 902, memory 904, and I/O Components 944, which may be configured to communicate with each other via a bus 946. In an example embodiment, the Processors 902 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a Processor 906 and a Processor 910 that execute the instructions 908. The term “processor” is intended to include multi-core processors that may comprise two or more independent processors (sometimes referred to as “cores”) that may execute instructions contemporaneously. Although FIG. 9 shows multiple Processors 902, the machine 900 may include a single processor with a single core, a single processor with multiple cores (e.g., a multi-core processor), multiple processors with a single core, multiple processors with multiples cores, or any combination thereof.

The memory 904 includes a main memory 912, a static memory 914, and a storage unit 916, both accessible to the Processors 902 via the bus 946. The main memory 904, the static memory 914, and storage unit 916 store the instructions 908 embodying any one or more of the methodologies or functions described herein. The instructions 908 may also reside, completely or partially, within the main memory 912, within the static memory 914, within machine-readable medium 918 within the storage unit 916, within at least one of the Processors 902 (e.g., within the processor's cache memory), or any suitable combination thereof, during execution thereof by the machine 900.

The I/O Components 944 may include a wide variety of components to receive input, provide output, produce output, transmit information, exchange information, capture measurements, and so on. The specific I/O Components 944 that are included in a particular machine will depend on the type of machine. For example, portable machines such as mobile phones may include a touch input device or other such input mechanisms, while a headless server machine will likely not include such a touch input device. It will be appreciated that the I/O Components 944 may include many other components that are not shown in FIG. 9. In various example embodiments, the I/O Components 944 may include output Components 930 and input Components 932. The output Components 930 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input Components 932 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O Components 944 may include biometric Components 934, motion Components 936, environmental Components 938, or position Components 940, among a wide array of other Components. For example, the biometric Components 934 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 836 include acceleration sensor components (e.g., accelerometer), gravitation sensor components, rotation sensor components (e.g., gyroscope), and so forth. The environmental Components 938 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position Components 940 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O Components 944 further include communication Components 942 operable to couple the machine 900 to a network 922 or devices 924 via a coupling 926 and a coupling 928, respectively. For example, the communication Components 942 may include a network interface component or another suitable device to interface with the network 922. In further examples, the communication Components 942 may include wired communication components, wireless communication components, cellular communication components, Near Field Communication (NFC) components, Bluetooth^{®}components (e.g., Bluetooth^{®}Low Energy), Wi-Fi^{®}components, and other communication components to provide communication via other modalities. The devices 924 may be another machine or any of a wide variety of peripheral devices (e.g., a peripheral device coupled via a USB).

Moreover, the communication Components 942 may detect identifiers or include Components operable to detect identifiers. For example, the communication Components 942 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication Components 942, such as location via Internet Protocol (IP) geolocation, location via Wi-Fi® signal triangulation, location via detecting an NFC beacon signal that may indicate a particular location, and so forth.

The various memories (e.g., memory 904, main memory 912, static memory 914, and/or memory of the Processors 902) and/or storage unit 916 may store one or more sets of instructions and data structures (e.g., software) embodying or used by any one or more of the methodologies or functions described herein. These instructions (e.g., the instructions 908), when executed by Processors 902, cause various operations to implement the disclosed embodiments.

The instructions 908 may be transmitted or received over the network 922, using a transmission medium, via a network interface device (e.g., a network interface Component included in the communication Components 942) and using any one of a number of well-known transfer protocols (e.g., hypertext transfer protocol (HTTP)). Similarly, the instructions 908 may be transmitted or received using a transmission medium via the coupling 928 (e.g., a peer-to-peer coupling) to the devices 924.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

### EXAMPLES

Example 1 is a computer-implemented method comprising: initiating, at a client, a request to be sent to a server of a mesh network; transmitting the request through a plurality of intermediary components in the mesh network; receiving, at the client, a response from the server, wherein the response contains latency data injected into headers of the response from the server using Hypertext Transfer Protocol (HTTP) router filters; and calculating component-specific latencies based on measurement values from the latency data in the headers.

In Example 2, the subject matter of Example 1 includes, wherein the latency data is injected at the plurality of intermediary components comprising: an application proxy, a load balancer, a gateway, and a service proxy.

In Example 3, the subject matter of Example 2 includes, wherein the latency data comprises unique key names for each component's latency data in the headers of the response, each unique key name having a corresponding measurement value.

In Example 4, the subject matter of Example 3 includes, wherein the unique key names indicate when the response passed through each intermediary component.

In Example 5, the subject matter of Examples 1-4 includes, wherein calculating the component-specific latencies comprises: subtracting a first duration value in the headers of the response from a second duration value in the headers of the response to determine a component network latency.

In Example 6, the subject matter of Examples 1-5 includes, wherein the latency data comprises one or more of: a client duration value; a gateway duration value; an upstream duration value; or a server duration value.

In Example 7, the subject matter of Example 6 includes, wherein calculating the component-specific latencies comprises: subtracting the server duration value from the client duration value to determine a mesh network latency.

In Example 8, the subject matter of Examples 1-7 includes, constructing histogram data from the component-specific latencies; and distributing the component-specific latencies in the histogram data based on expected latency ranges for each intermediary component.

In Example 9, the subject matter of Example 8 includes, detecting anomalies based on deviations in the histogram data.

In Example 10, the subject matter of Examples 1-9 includes, generating visualization data showing latency breakdown across components of the mesh network based on the component-specific latencies; and displaying the visualization data in a dashboard user interface.

In Example 11, the subject matter of Examples 1-10 includes, generating one of a Service Level Indicator (SLI) visualization or a Service Level Objective (SLO) visualization based on the component-specific latencies; generating an alert based on one of the SLI visualization or the SLO visualization; and enabling tracing by providing latency measurements for each component in a request path, HTTP status codes and mesh-specific measurements for each span.

In Example 12, the subject matter of Examples 1-11 includes, wherein injecting the latency data further comprises injecting the latency data at a plurality of components of a workload, a platform, or the client, wherein an overhead of injected latency data is less than a preset overhead.

In Example 13, the subject matter of Examples 1-12 includes, constructing histogram data to fit the component-specific latencies.

In Example 14, the subject matter of Examples 1-13 includes, wherein the client is configured as a platform dependency within a client application, wherein the client application receives and operates a filter plugin that is configured to calculate the component-specific latencies.

In Example 15, the subject matter of Examples 1-14 includes, wherein the method is implemented across a portion of workload services and is cross-platform, further comprising support for client dependencies within client applications and accommodating an integration of a filter plugin configured to calculate the component-specific latencies.

Example 16 is a computing apparatus comprising: a Processor; and a memory storing instructions that, when executed by the Processor, configure the apparatus to: initiate, at a client, a request to be sent to a server of a mesh network; transmit the request through a plurality of intermediary components in the mesh network; receive, at the client, a response from the server, wherein the response contains latency data injected into headers of the response from the server using Hypertext Transfer Protocol (HTTP) router filters; calculate component-specific latencies based on measurement values from the latency data in the headers.

In Example 17, the subject matter of Example 16 includes, wherein the latency data is injected at the plurality of intermediary components comprising: an application proxy, a load balancer, a gateway, and a service proxy.

In Example 18, the subject matter of Example 17 includes, wherein the latency data comprises unique key names for each component's latency data in the headers of the response, each unique key name having a corresponding measurement value that indicates when the response passed through each intermediary component.

In Example 19, the subject matter of Examples 16-18 includes, wherein calculating the component-specific latencies comprises: subtract a first duration value in the headers of the response from a second duration value in the headers of the response to determine a component network latency.

Example 20 is a non-transitory computer-readable storage medium, the non-transitory computer-readable storage medium including instructions that when executed by a computer, cause the computer to perform operations comprising: initiate, at a client, a request to be sent to a server of a mesh network; transmitting the request through a plurality of intermediary components in the mesh network; receiving, at the client, a response from the server, wherein the response contains latency data injected into headers of the response from the server using Hypertext Transfer Protocol (HTTP) router filters; and calculating component-specific latencies based on measurement values from the latency data in the headers.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

What is claimed is:

1. A computer-implemented method comprising:
initiating, at a client, a request to be sent to a server of a mesh network;
transmitting the request through a plurality of intermediary components in the mesh network;
receiving, at the client, a response from the server, wherein the response contains latency data injected into headers of the response from the server using Hypertext Transfer Protocol (HTTP) router filters; and
calculating component-specific latencies based on measurement values from the latency data in the headers.

2. The computer-implemented method of claim 1, wherein the latency data is injected at the plurality of intermediary components comprising: an application proxy, a load balancer, a gateway, and a service proxy.

3. The computer-implemented method of claim 2, wherein the latency data comprises unique key names for each component's latency data in the headers of the response, each unique key name having a corresponding measurement value.

4. The computer-implemented method of claim 3, wherein the unique key names indicate when the response passed through each intermediary component.

5. The computer-implemented method of claim 1, wherein calculating the component-specific latencies comprises:
subtracting a first duration value in the headers of the response from a second duration value in the headers of the response to determine a component network latency.

6. The computer-implemented method of claim 1, wherein the latency data comprises one or more of:
a client duration value;
a gateway duration value;
an upstream duration value; or
a server duration value.

7. The computer-implemented method of claim 6, wherein calculating the component-specific latencies comprises:
subtracting the server duration value from the client duration value to determine a mesh network latency.

8. The computer-implemented method of claim 1, further comprising:
constructing histogram data from the component-specific latencies; and
distributing the component-specific latencies in the histogram data based on expected latency ranges for each intermediary component.

9. The computer-implemented method of claim 8, further comprising:
detecting anomalies based on deviations in the histogram data.

10. The computer-implemented method of claim 1, further comprising:
generating visualization data showing latency breakdown across components of the mesh network based on the component-specific latencies; and
displaying the visualization data in a dashboard user interface.

11. The computer-implemented method of claim 1, further comprising:
generating one of a Service Level Indicator (SLI) visualization or a Service Level Objective (SLO) visualization based on the component-specific latencies;
generating an alert based on one of the SLI visualization or the SLO visualization; and
enabling tracing by providing latency measurements for each component in a request path, HTTP status codes and mesh-specific measurements for each span.

12. The computer-implemented method of claim 1, wherein injecting the latency data further comprises injecting the latency data at a plurality of components of a workload, a platform, or the client, wherein an overhead of injected latency data is less than a preset overhead.

13. The computer-implemented method of claim 1, further comprising:
constructing histogram data to fit the component-specific latencies.

14. The computer-implemented method of claim 1, wherein the client is configured as a platform dependency within a client application, wherein the client application receives and operates a filter plugin that is configured to calculate the component-specific latencies.

15. The computer-implemented method of claim 1, wherein the method is implemented across a portion of workload services and is cross-platform, further comprising support for client dependencies within client applications and accommodating an integration of a filter plugin configured to calculate the component-specific latencies.

16. A computing apparatus comprising:
a processor; and
a memory storing instructions that, when executed by the processor, configure the apparatus to:
initiate, at a client, a request to be sent to a server of a mesh network;
transmit the request through a plurality of intermediary components in the mesh network;
receive, at the client, a response from the server, wherein the response contains latency data injected into headers of the response from the server using Hypertext Transfer Protocol (HTTP) router filters; and
calculate component-specific latencies based on measurement values from the latency data in the headers.

17. The computing apparatus of claim 16, wherein the latency data is injected at the plurality of intermediary components comprising: an application proxy, a load balancer, a gateway, and a service proxy.

18. The computing apparatus of claim 17, wherein the latency data comprises unique key names for each component's latency data in the headers of the response, each unique key name having a corresponding measurement value that indicates when the response passed through each intermediary component.

19. The computing apparatus of claim 16, wherein calculating the component-specific latencies comprises:
subtract a first duration value in the headers of the response from a second duration value in the headers of the response to determine a component network latency.

20. A non-transitory computer-readable storage medium, the non-transitory computer-readable storage medium including instructions that when executed by a computer, cause the computer to perform operations comprising:
initiate, at a client, a request to be sent to a server of a mesh network;
transmitting the request through a plurality of intermediary components in the mesh network;
receiving, at the client, a response from the server, wherein the response contains latency data injected into headers of the response from the server using Hypertext Transfer Protocol (HTTP) router filters; and
calculating component-specific latencies based on measurement values from the latency data in the headers.
